(19) United States
(12) Patent Application Publication
(10) Pub. No.: US 2026/0122102 A1
(43) Pub. Date: Apr. 30, 2026

(54) REAL-TIME CYBERSECURITY STRATEGIC PRIORITIZATION SYSTEMS AND METHODS

(71) Applicant: T-Mobile USA, Inc., Bellevue, WA (US)

(72) Inventors: Christopher John Spanton, Gig Harbor, WA (US); Jeffrey Scott Simon, Bellevue, WA (US)

(21) Appl. No.: 19/368,455

(22) Filed: Oct. 24, 2025

Related U.S. Application Data
(60) Provisional application No. 63/711,650, filed on Oct. 24, 2024.

(51) Int. Cl. H04L 9/40; G06F 8/30; G06N 20/00

(52) U.S. Cl. CPC H04L 63/1441; G06F 8/30; G06N 20/00; H04L 63/1425

(57) ABSTRACT

The system inputs at least one security log file from a first data domain into a first machine learning (ML) model. The system compute, using an output from the first ML model, a weighted sentiment value for one or more of the multiple cybersecurity events. The system detects, using a second ML model, an anomaly in a first cybersecurity event of the multiple cybersecurity events. The system correlates, using a third ML model, the anomaly in the first cybersecurity event to a different anomaly in a second cybersecurity event associated with a second data domain. The system determines, using a fourth machine learning model, a cybersecurity action to minimize a cyberattack. The system determines, using the fourth model, a predicted impact to the telecommunication network associated. The system generates a prioritization ranking of every cybersecurity action and executes each cybersecurity action based on the prioritization ranking.

### CROSS-REFERENCE TO RELATED APPLICATIONS

The present application claims the benefit of U.S. Provisional Application No. 63/711,650, filed on October 24, 2024, which is incorporated herein by reference in its entirety.

### BACKGROUND

Computer security, cybersecurity, digital security, or information technology security (IT security) is the protection of computer systems and networks from attacks by malicious actors that may result in unauthorized information disclosure, theft of, or damage to hardware, software, or data, as well as from the disruption or misdirection of the services they provide.

The cybersecurity field is significant due to the expanded reliance on computer systems, the Internet, and wireless network standards such as Bluetooth and Wi-Fi. It is also significant due to the growth of smart devices, including smartphones, televisions, and the various devices that constitute the Internet of things. Cybersecurity is one of the most significant challenges of the contemporary world, due to both the complexity of information systems and the societies they support. Security is of especially high importance for systems that govern large-scale systems with far-reaching physical effects.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram of an example transformer.

FIG. 4 is a block diagram of an embodiment of the system.

FIG. 5 is a flowchart of a process for performing strategic cybersecurity prioritization.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Advancements in information technology (IT) infrastructure are constantly occurring. IT infrastructure can include telecommunication network devices and/or telecommunication core network equipment. As IT technology advances, so do the challenges of implementing effective cybersecurity strategies. Software constantly changes, introducing new issues and vulnerabilities that open the IT infrastructure to various cyberattacks. Organizations are unaware of the risks within their IT infrastructure and, hence, fail to have cybersecurity countermeasures in place until it’s too late.

Additionally, these IT infrastructures face cyberattacks using new advanced technology that traditional cybersecurity systems are not equipped to handle. Attackers consistently try a multitude of cyber-attacks against their targets with a determination that one of them would result in a security breach. Advancements in machine learning (ML) models, such as large language models (LLMs), allow cyber attackers to attack IT infrastructure in more ways and in a quicker, more efficient manner. Traditional cybersecurity systems are ill-equipped to detect and handle the kinds of attacks implanted using an ML model.

Traditional cybersecurity systems employ a team of specialists to monitor possible cybersecurity events (events) contained in cybersecurity log files, looking for the presence of a cyberattack. This process becomes greatly inefficient as an organization grows and begins to generate daily security log files containing millions or billions of events. A single event can also correspond to multiple different cybersecurity threats, meaning that a single event does not necessarily indicate the presence of a more significant cybersecurity threat. Therefore, traditional cybersecurity systems cannot analyze every event when determining the presence of and stopping a larger cybersecurity event. This can lead to an event being incorrectly assigned to the wrong type of cybersecurity threat, allowing an attacker to continue exploiting a vulnerability. Thus, the process to find and stop a cyberattack can take days or weeks. In contrast, advancements in cyberattacks allow an attacker to breach an organization's IT infrastructure in minutes or hours. Even when a traditional cybersecurity system takes action and stops a cyberattack because a majority of the events were never analyzed, the impact on the organization or the IT infrastructure as a whole is not known until well after the action is taken.

The disclosed technology counteracts these inefficiencies and advancements in cyberattacks by using an ML model, such as an LLM to analyze and act upon all the data found in the cybersecurity log files. The system receives real-time datasets containing the cybersecurity log files and inputs the cybersecurity log files into the ML model. The system analyzes each event in the cybersecurity log file to determine the cause of the event, whether the event is part of a larger cybersecurity event, and/or the action that should be taken in response to the event. The analysis by the ML model allows the system to gain insights from every event and remove the underlying data leaving for example, just a sentiment value for the event, which the system can use to detect and prevent future cyberattacks. Gaining insights from all past events helps the system detect cyberattacks in real-time, prevent cyberattacks, and/or reduce the amount of time a cyber attacker has access to the IT infrastructure. Also, because the system removes the underlying data, it can be located on the telecommunication network, allowing the system to protect any designated piece of IT infrastructure connected to the network.

The system outputs the generated insights, and either the system or a user can determine the appropriate action to take in response to the cyberattack. The actions enable the system to counteract a cyberattack in real time even when the cyber attacker is using an ML model during the cyberattack. To determine the appropriate action, the system is trained to understand how an attacker would exploit a vulnerability and the risk of that vulnerability, which reduces the time for the exploit to be found and stopped. For example, based on the determined action, the system can generate coding language (code) designed to prevent or stop the cyberattack. The system then executes the determined action.

Executing the determined action can have consequences for the IT infrastructure or the organization as a whole. The system is trained to determine the impact of its actions on the IT infrastructure and organization. The system prioritizes the actions it takes based on the criticality of the impact. For example, when the action affects sensitive or confidential information, the action can be prioritized, or an action that results in a more significant impact on the business can be prioritized. Prioritization allows the system to properly designate resources for the most significant cyberattacks that have the highest likelihood of compromising the IT infrastructure and/or organization, while not taking resources away from other vital infrastructure needed by the organization. Therefore, the system performs real-time cybersecurity defense while minimizing the impact of the actions.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

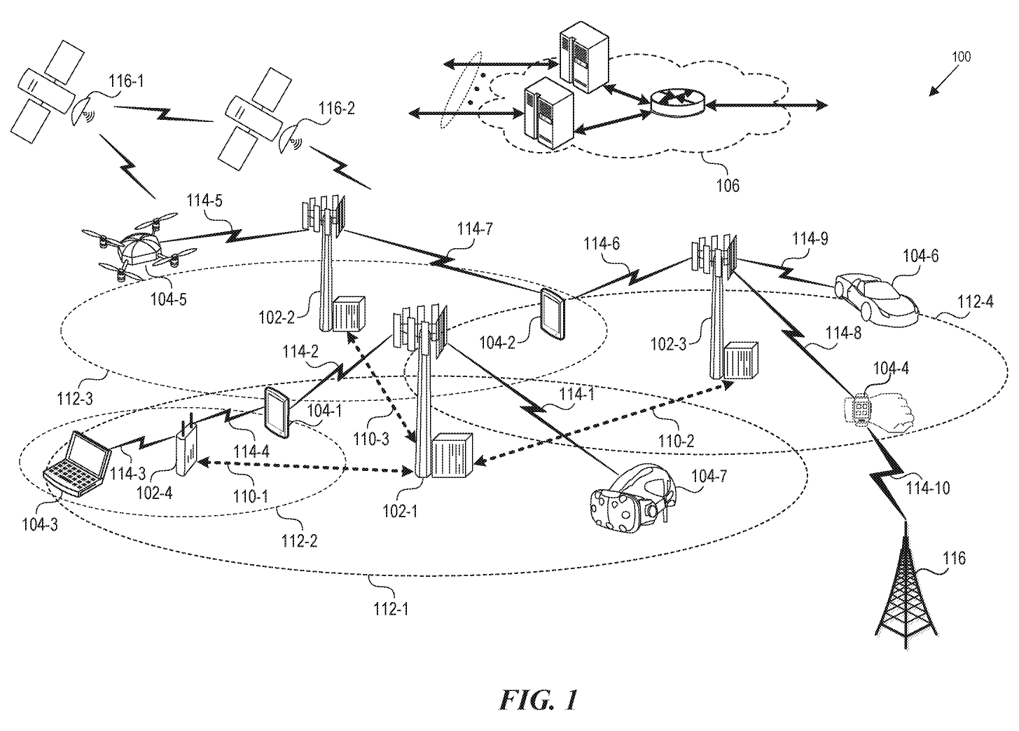

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

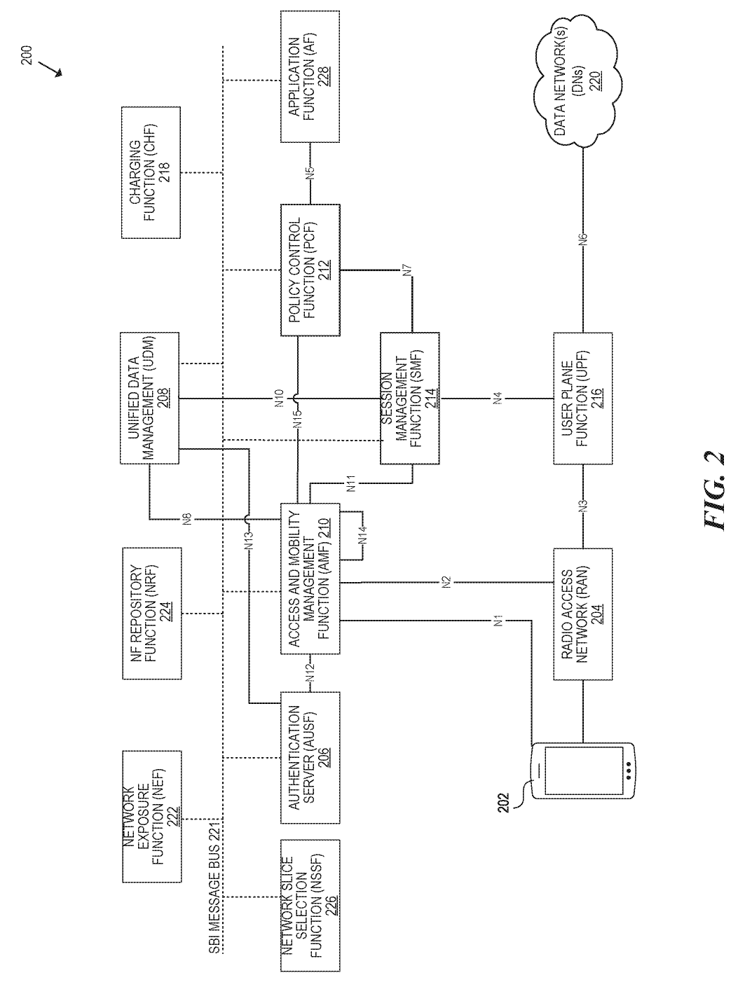

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model’s accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publically-available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

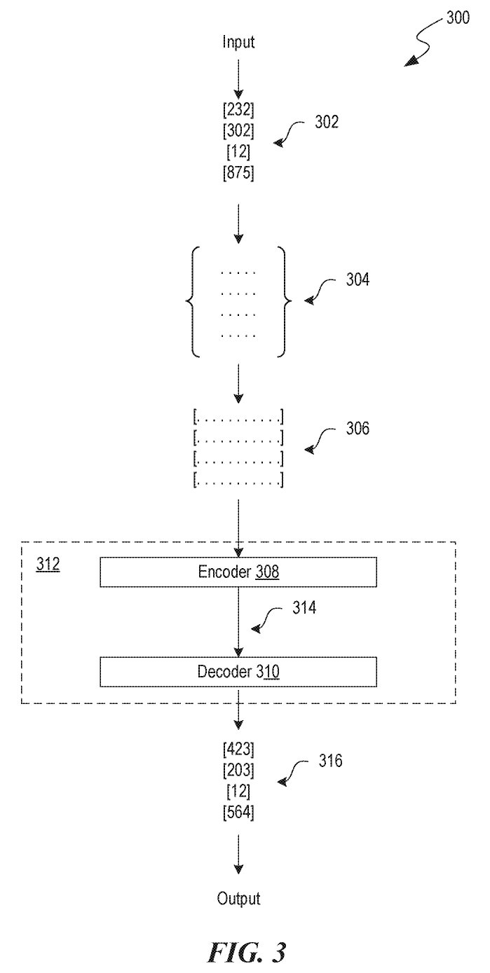

FIG. 3 is a block diagram of an example transformer 312. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 312 includes an encoder 308 (which can comprise one or more encoder layers/blocks connected in series) and a decoder 310 (which can comprise one or more decoder layers/blocks connected in series). Generally, the encoder 308 and the decoder 310 each include a plurality of neural network layers, at least one of which can be a self-attention layer. The parameters of the neural network layers can be referred to as the parameters of the language model.

The transformer 312 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user’s writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 312 is trained to perform certain functions on other input formats than natural language input. For example, the input can include objects, images, audio content, or video content, or a combination thereof.

The transformer 312 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 3 illustrates an example of how the transformer 312 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 3, a short sequence of tokens 302 corresponding to the input text is illustrated as input to the transformer 312. Tokenization of the text sequence into the tokens 302 can be performed by some pre-processing tokenization module such as, for example, a byte-pair encoding tokenizer (the “pre” referring to the tokenization occurring prior to the processing of the tokenized input by the LLM), which is not shown in FIG. 3 for simplicity. In general, the token sequence that is inputted to the transformer 312 can be of any length up to a maximum length defined based on the dimensions of the transformer 312. Each token 302 in the token sequence is converted into an embedding vector 306 (also referred to simply as an embedding 306). An embedding 306 is a learned numerical representation (such as, for example, a vector) of a token that captures some semantic meaning of the text segment represented by the token 302. The embedding 306 represents the text segment corresponding to the token 302 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 306 corresponding to the “write” token will be closer to another embedding corresponding to the “jot down” token in the vector space as compared to the distance between the embedding 306 corresponding to the “write” token and another embedding corresponding to the “summary” token.

The vector space can be defined by the dimensions and values of the embedding vectors. Various techniques can be used to convert a token 302 to an embedding 306. For example, another trained ML model can be used to convert the token 302 into an embedding 306. In particular, another trained ML model can be used to convert the token 302 into an embedding 306 in a way that encodes additional information into the embedding 306 (e.g., a trained ML model can encode positional information about the position of the token 302 in the text sequence into the embedding 306). In some examples, the numerical value of the token 302 can be used to look up the corresponding embedding in an embedding matrix 304 (which can be learned during training of the transformer 312).

The generated embeddings 306 are input into the encoder 308. The encoder 308 serves to encode the embeddings 306 into feature vectors 314 that represent the latent features of the embeddings 306. The encoder 308 can encode positional information (i.e., information about the sequence of the input) in the feature vectors 314. The feature vectors 314 can have very high dimensionality (e.g., on the order of thousands or tens of thousands), with each element in a feature vector 314 corresponding to a respective feature. The numerical weight of each element in a feature vector 314 represents the importance of the corresponding feature. The space of all possible feature vectors 314 that can be generated by the encoder 308 can be referred to as the latent space or feature space.

Conceptually, the decoder 310 is designed to map the features represented by the feature vectors 314 into meaningful output, which can depend on the task that was assigned to the transformer 312. For example, if the transformer 312 is used for a translation task, the decoder 310 can map the feature vectors 314 into text output in a target language different from the language of the original tokens 302. Generally, in a generative language model, the decoder 310 serves to decode the feature vectors 314 into a sequence of tokens. The decoder 310 can generate output tokens 316 one by one. Each output token 316 can be fed back as input to the decoder 310 in order to generate the next output token 316. By feeding back the generated output and applying self-attention, the decoder 310 is able to generate a sequence of output tokens 316 that has sequential meaning (e.g., the resulting output text sequence is understandable as a sentence and obeys grammatical rules). The decoder 310 can generate output tokens 316 until a special [EOT] token (indicating the end of the text) is generated. The resulting sequence of output tokens 316 can then be converted to a text sequence in post-processing. For example, each output token 316 can be an integer number that corresponds to a vocabulary index. By looking up the text segment using the vocabulary index, the text segment corresponding to each output token 316 can be retrieved, the text segments can be concatenated together, and the final output text sequence can be obtained.

In some examples, the input provided to the transformer 312 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally, or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Machine Learning Cybersecurity Prioritization

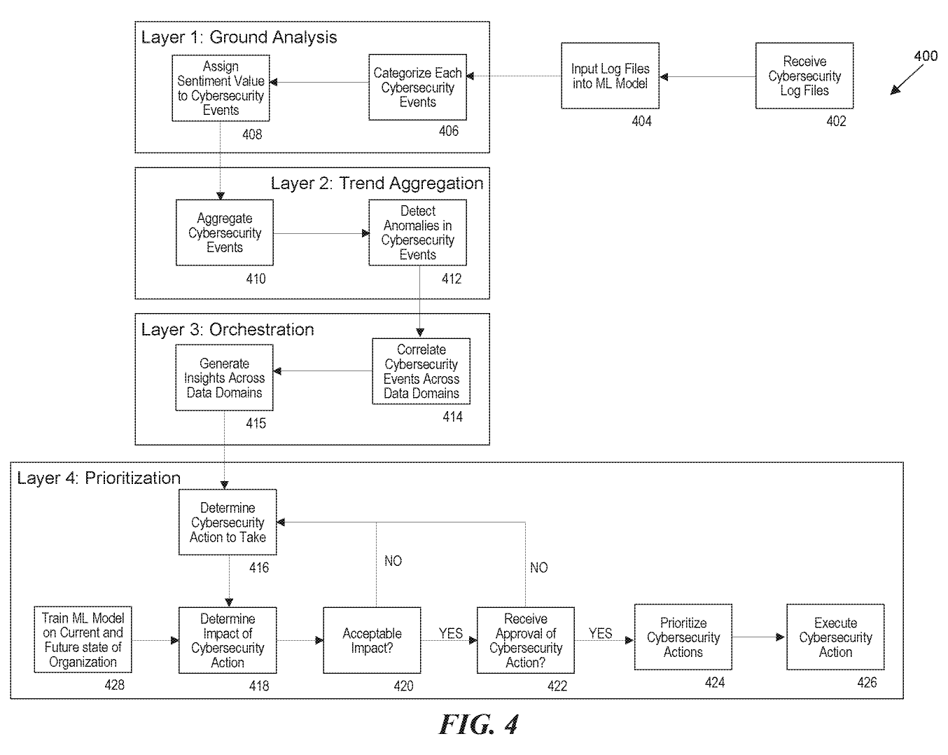

FIG. 4 illustrates a block diagram of an embodiment 400 of the system. The system can be divided into multiple layers, where each layer focuses on gaining a different insight and narrows the scope of the insights and analyzed data to be able to execute a cybersecurity action. Generally, at layer 1, the system analyzes and tags the cybersecurity events separately based on the data domain (e.g., origin location of the cybersecurity events). At layer 2, the system determines trends and anomalies within each data domain. At layer 3, the system determines trends and anomalies across data domains. At layer 4, the system determines an action to take and executes said action based on an expected impact.

At 402, the system receives at least one cybersecurity log file. The data within the cybersecurity log file can include millions and/or billions of transactions representing cybersecurity events that may or may not be indicative of a cyberattack. At 404, the system inputs the log file into an ML model. The ML model can be an LLM or any similar model that can analyze data and output insights about the data. In some embodiments, due to the multitude of data multiple similarly trained ML models are used, where each ML model outputs insights about a predetermined number of events. The ML model can be trained based on historical log files and/or a specifically made data training set. Inputting every event in the log file allows the system to generate insights that relate to every possible cybersecurity event. This enables the system to detect every possible cyberattack in real-time or near real-time (e.g., within seconds and/or minutes of the start of the cyberattack).

Layer 1 can begin at 406. At 406, the system categorizes or tags each cybersecurity event using the ML model. The events can be categorized based on the type of cyberattack, data domain, time of event, geographic location, etc. A data domain is a logical grouping of data that shares a common meaning or purpose, such as a customer or data source (e.g., certain processes or IT infrastructure). At 408, the system assigns a sentiment value or risk indicator to every cybersecurity event included in the log file. The sentiment value can be determined by assigning different weighted values or factors to each event. The different categories of the weighted values are consistent across data domains, but the weighted values themselves can differ. For example, a certain weighted value category can have a large impact for one data domain but be irrelevant for a different data domain. The weighted values, therefore, help normalize the sentiment values across data domains. In some embodiments, the sentiment value is calculated based on the expected risk of the event turning into a cyberattack, the type of cyberattack, the technology used in the cyberattack, and/or whether the cybersecurity event is part of a more significant cyberattack. For example, a cybersecurity event that corresponds to a cyberattack that can be prevented by patching a small bug in a piece of software can be assigned a lower sentiment value or severity rating. Conversely, a cybersecurity event that corresponds to a more significant cyberattack such as those based on a connection other cybersecurity events in different data domains and/or a cyberattack using an ML model can be assigned a higher sentiment value. Once the sentiment value is determined, the system can dispose of the underlying log data and only retain the sentiment values for each cybersecurity event.

Layer 2 can begin at 410. At 410, the system aggregates the cybersecurity events over time (e.g., one day, one week, one month, one quarter) for each data domain. Not every cybersecurity event is indicative of a cyberattack when viewed within a single instant or short timeframe (e.g., one minute, five minutes, one hour, one day) due to factors such as, the processes of a given data domain were not active during the short timeframe. The aggregation timeframe can be data domain specific and/or the system can use the same timeframe for all data domains. Aggregating the cybersecurity events over time, therefore, yields more accurate insights into the cybersecurity events and better enables the detection of a cyberattack.

At 412, using the ML model, the system, for each data domain separately, detects anomalies in the cybersecurity events based on the determined sentiment value and the aggregated cybersecurity events. For example, based on the computed sentiment value, the ML model can categorize a cybersecurity event as a non-event, nonissue, an alert, an error, and/or requiring immediate action. Categorizing the cybersecurity events enables the system to detect anomalies by determining patterns between the cybersecurity events more efficiently. For example, a cybersecurity event with a sentiment value beyond a threshold value can be indicative of an anomaly and/or multiple identical and/or similar cybersecurity events within a given timeframe can be indicative of an anomaly whether or not the sentiment value is beyond a threshold value.

Layer 3 can begin at 414. At 414, the system correlates the cybersecurity events across data domains to determine trends and patterns across the data domains. Using the ML model and/or a different ML model, the system links cybersecurity events from different data domains to determine if a collection of cybersecurity events from different data domains is indicative of a cyberattack. Based on historical data and training, the ML model is able to determine that two or more cybersecurity events are related based on factors such as time of each cybersecurity event and/or cause of each cybersecurity event.

For example, for a given time period (e.g., five minute period) a log source for a patching solution may yield a cybersecurity event with a low sentiment value, while the log source for a firewall system may yield a cybersecurity event with a high sentiment value. Conventional systems would not be able to detect a correlation between these data domains because the patching solution had a low sentiment value and would be considered a non-event. However, this time period could be when the patching solution is not active as the patching solution operates periodically. Therefore, because the system aggregates the cybersecurity events over longer timeframes, the system can detect an anomaly in the log file generated by the patching solution and then correlate the anomaly to an anomaly in the firewall system over the same time period.

At 415, the system generates insights from across data domains. Insights aggregated from the cybersecurity events can include information about the cause of the event, whether the cybersecurity event is a standalone event or part of a larger cybersecurity event (e.g., correlated to other anomalies in different data domains), and/or if the event is similar to a past event encountered by the system. The insights can indicate the method that a cyber attacker is using to gain access to the IT infrastructure and whether the cyber attacker is using an ML model in their attack. Because the system only retains past sentiment values, the system only needs to review past insights and sentiment values when determining what action to take instead of having to review all of the underlying data contained in the log files. This also allows the system to make decisions in the context of all past events without needing to retain all of the past underlying data.

Layer 4 can begin at 416. At 416, the system determines the cybersecurity action to take using an ML model. The ML model is trained to understand different security vulnerabilities, allowing the system to better determine the appropriate action to counter the cybersecurity threat. The ML model can be trained on historical data that indicates actions taken in response to cyberattacks and/or a specifically generated training set. The ML model can be the same model and/or a different model used at layers 1-3. The action taken can be any action that either prevents, stops, minimizes, etc. a cyberattack in real-time by manipulating the cybersecurity defenses put in place. For example, the action can include generating code, which can patch a software vulnerability on a device and/or a piece of IT infrastructure, counteract an active cyberattack, and/or generate application programming interface (API) calls to manipulate the environment based on the aggregated insights. The action can also include changing a firewall rule, blocking a network packet from being delivered, and/or quarantining the network packet. The action taken is dependent on the type of cyberattack occurring and/or the technology being used by the cyber attacker, meaning the system implements larger, more robust actions when a cyberattack is using, for example, an ML model. Depending on the severity of the cyberattack and the best methods of minimizing or stopping the attack, the system can determine that a different action should be performed that can stop the entire attack or that multiple actions must be performed to stop or minimize the attack. Additionally, the system, based on the insights, can determine whether the action is minimizing or stopping a single aspect of the cyberattack or the whole cyberattack. Based on the correlated cybersecurity events, the system can perform an action that corrects an anomaly in a single data domain, which can have the effect of correcting or preventing anomalies in the correlated data domain. For example, the system can determine that an action to fix an anomaly in the patching solution can also correct an anomaly in the firewall system by closing some vulnerability and/or access point. Alternatively, and/or additionally, the system can determine multiple actions are required to correct each anomaly and minimize and/or stop a cyberattack. In one embodiment, the model outputs the insights along with a ranking of the events and the metadata of the events in a human-readable format. A user can then determine an appropriate action to take and input that action into the system. In another embodiment, the system can determine what action needs to be taken based on the insights.

At 428, the system trains an ML model using the data related to the current and future state of the organization. The ML model can be the same ML model and/or an entirely different ML model used to generate the insights. The system trains the ML model on the current and future state of the organization so that the impact on the organization caused by the actions taken by the system can be determined. The current state can refer to the current allocation of resources and which processes (e.g., data domains) are currently being prioritized. The future state can refer to the planned allocation of resources including which processes will be prioritized and how these processes will be prioritized at a future date and planned future infrastructure and/or technology that may replace current infrastructure.

The model needs to be trained on the planned future state of the organization so that the system can determine which actions to take that align with the planned future state of the organization. For example, a proposed cybersecurity action may prevent or stop a cyberattack, but can have unintended consequences, such as pulling resources from a prioritized data domain in the future state leaving that data domain more susceptible to cyberattacks and/or make cybersecurity changes that effect the access to data and/or different data domains.

At 418, the system determines the impact of the cybersecurity action using the trained ML model and/or a different trained ML model. The system determines the impact of the action by using the ML model to analyze the state of the organization before taking the action and predicting the state of the organization after taking the action. The system then determines if the state of the organization after taking the action aligns with the planned future state of the organization. Additionally, the system compares the impact on the future state of the organization caused by performing the action and not performing the action. To determine the impact, the system can be trained by performing the determined action and then analyzing the resulting impact on the organization.

At 420, the system determines if the impact on the organization is acceptable. For example, the system can determine that patching the software vulnerability has a minimal impact on the organization compared to the benefit of preventing a cyber attacker from exploiting a software vulnerability. The system can determine that changing a firewall rule would prevent or stop a cyberattack, but it goes against the rules defining the program that governs the usage of data loss prevention and the intended future state of the organization. The system in this scenario can determine that the impact is unacceptable. The system can also determine that blocking or rerouting the network packets associated with a cyberattack can have unintended consequences for the organization. When the system determines that blocking the network packet would prevent important data from being delivered, the system can determine that the impact is unacceptable. Although, when the system determines that blocking the network packet would prevent a more significant cybersecurity event from occurring, the system can determine that the impact is acceptable. When the system determines that the impact is unacceptable, the system returns to 416 and determines a new cybersecurity action.

When determining which action to take, the system can analyze the current cybersecurity events and the past historical cybersecurity events and make recommendations to reallocate resources, and/or implement new tools to address the anomalies in the log data to prevent future issues and direct the current state toward the future state. In some embodiments, the system can allocate resources in a manner that goes against the future state in order to stop a cyberattack in the short term but can modify the cybersecurity priorities and actions over a longer period of time to align with the planned future state.

At 422, the system determines if the approval of the cybersecurity action is received. The system can either receive approval from a user or be preapproved to take certain types of actions. When the action is not approved, the system returns to 416 and determines a new cybersecurity action. At 424, the system prioritizes all approved cybersecurity actions. The system can use high-level decision logic and/or a deep neural ML ranking to analyze historical decisions and the current cybersecurity actions to rank and prioritize each cybersecurity action. For example, when the cyberattack affects sensitive or confidential information on less controlled networks, the cybersecurity action can be prioritized, or a cyberattack that affects multiple different data domains can be prioritized. Conversely, anomalies affecting data domains that are being phased out and/or are becoming obsolete can be deprioritized. Regression testing can be used to correlate the prioritization against a dataset of past prioritizations containing both effective and ineffective prioritizations. The regression testing ensures that new prioritizations do not have the same issues experienced when past prioritizations were created. The prioritization and the insights generated by the ML model and the system can be made available to users via a chat-style interface to deliver insights and allow users to ask questions related to the insights and data. At 426, the system executes the cybersecurity action to prevent or stop a cyberattack. When an action is taken, subsequent actions can be executed as changes to the cyberattack occur.

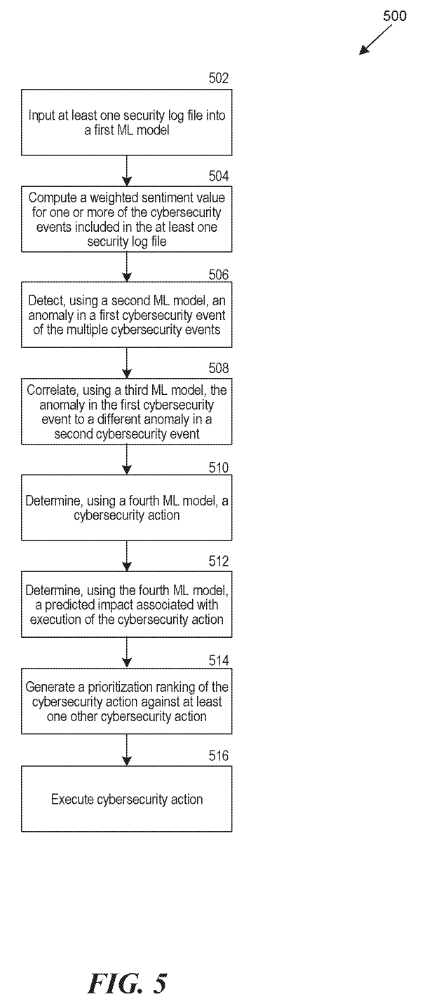

FIG. 5 illustrates a flow diagram of an embodiment of the system. In one example, the system includes at least one hardware processor and at least one non-transitory memory storing instructions, which, when executed by the at least one hardware processor, cause the system to perform the process 500.

At 502, the system inputs at least one security log file into a first machine learning (ML) model. The at least one security log file is generated at a first data domain of a telecommunication network. The at least one security log file includes multiple cybersecurity events. At 504, the system computes, using an output from the first ML model, a weighted sentiment value for one or more of the multiple cybersecurity events included in the at least one security log file. At 506, using the weighted sentiment scores, the system detects, using a second ML model, an anomaly in a first cybersecurity event of the multiple cybersecurity events.

At 508, the system correlates, using a third ML model, the anomaly in the first cybersecurity event to a different anomaly in a second cybersecurity event associated with a second data domain. In some examples, the system can aggregate the weighted sentiment value for the multiple cybersecurity events over a predetermined time period. In some other example, the system can further link, using the third ML model, the first cybersecurity event to the second cybersecurity event based on the detected anomaly or a detected pattern in the aggregated weighted sentiment value of the first cybersecurity event to the second cybersecurity event.

At 510, the system determines, using a fourth machine learning model, a cybersecurity action to minimize a cyberattack using the weighted sentiment value and the correlation between the first cybersecurity event and the second cybersecurity event. At 512, the system determines, using the fourth model, a predicted impact to the telecommunication network associated with execution of the cybersecurity action. In some examples, the system calculates an impact value indicative of the predicted impact and determines a new cybersecurity action when the impact value exceeds a threshold value. In some other examples, the first ML model, the second ML model, the third ML model, and the fourth ML model are the same ML model.

In some examples, the system can train the fourth ML model on a current state of the telecommunication network and a future state of the telecommunication network. The current state is indicative of current telecommunication infrastructure. The future state is indicative of planned telecommunication infrastructure and prioritized network assets. In some other examples, the system can further determine, using the fourth model, the impact to the future state based on executing the cybersecurity action and determine a new cybersecurity action when the determined predicted impact to the future state exceeds a threshold value.

At 514, the system generates a prioritization ranking of the cybersecurity action against at least one other cybersecurity action associated with a different cyberattack. At 516, the system executes each cybersecurity action based on the prioritization ranking. In some examples, the system can cause the telecommunication network to allocate additional resources to a process associated with the first data domain. In some other examples, the system can generate programming code, using the LLM, based on the determined cybersecurity action, where the programming code allows the system to execute the cybersecurity action. The system can execute the programing code. In yet some other examples, the system can generate, using the fourth ML model, a recommendation in human readable format to implement a new cybersecurity protocol, cybersecurity technology, or to remove a cybersecurity technology from the telecommunication network.

### Computer System

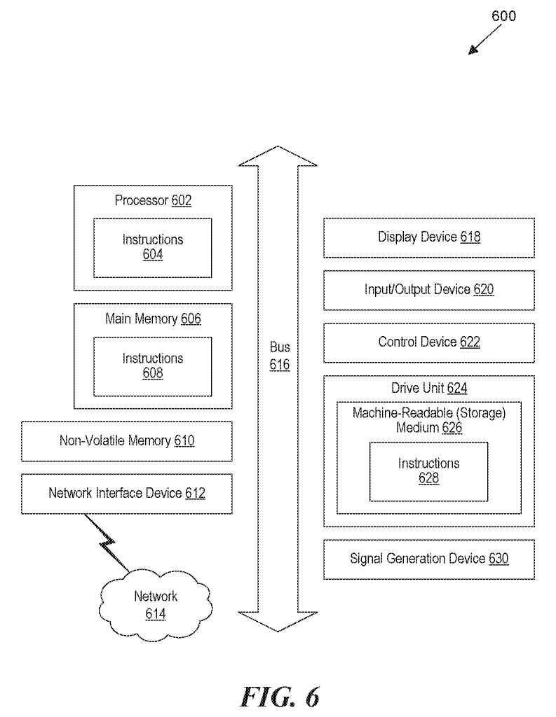

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A system comprising:
at least one hardware processor; and
at least one non-transitory memory storing instructions, which, when executed by the at least one hardware processor, cause the system to:
input at least one security log file into a first machine learning (ML) model,
wherein the at least one security log file is generated at a first data domain of a telecommunication network, and
wherein the at least one security log file includes multiple cybersecurity events;
compute, using an output from the first ML model, a weighted sentiment value for one or more of the multiple cybersecurity events included in the at least one security log file;
using the weighted sentiment scores, detect, using a second ML model, an anomaly in a first cybersecurity event of the multiple cybersecurity events;
correlate, using a third ML model, the anomaly in the first cybersecurity event to a different anomaly in a second cybersecurity event associated with a second data domain;
determine, using a fourth machine learning model, a cybersecurity action to minimize a cyberattack using the weighted sentiment value and the correlation between the first cybersecurity event and the second cybersecurity event;
determine, using the fourth model, a predicted impact to the telecommunication network associated with execution of the cybersecurity action;
generate a prioritization ranking of the cybersecurity action against at least one other cybersecurity action associated with a different cyberattack; and
execute each cybersecurity action based on the prioritization ranking.

2. The system of claim 1 further caused to:
aggregate the weighted sentiment value for the multiple cybersecurity events over a predetermined time period.

3. The system of claim 2 further caused to:
link, using the third ML model, the first cybersecurity event to the second cybersecurity event based on the detected anomaly or a detected pattern in the aggregated weighted sentiment value of the first cybersecurity event to the second cybersecurity event.

4. The system of claim 1 further caused to:
calculate an impact value indicative of the predicted impact;
determine a new cybersecurity action when the impact value exceeds a threshold value.

5. The system of claim 1, wherein executing the cybersecurity action, further causes the system to:
cause the telecommunication network to allocate additional resources to a process associated with the first data domain.

6. The system of claim 1, wherein executing the cybersecurity action, further causes the system to:
generate programming code, using the LLM, based on the determined cybersecurity action,
wherein the programming code allows the system to execute the cybersecurity action; and
execute the programing code.

7. The system of claim 1, wherein the first ML model, the second ML model, the third ML model, and the fourth ML model are the same ML model.

8. The system of claim 1, wherein the cybersecurity action further causes the system to:
generate, using the fourth ML model, a recommendation in human readable format to implement a new cybersecurity protocol, cybersecurity technology, or to remove a cybersecurity technology from the telecommunication network.

9. The system of claim 1 further caused to:
train the fourth ML model on a current state of the telecommunication network and a future state of the telecommunication network,
wherein the current state is indicative of current telecommunication infrastructure, and
wherein the future state is indicative of planned telecommunication infrastructure and prioritized network assets.

10. The system of claim 9, further caused to:
determine, using the fourth model, the impact to the future state based on executing the cybersecurity action; and
determine a new cybersecurity action when the determined predicted impact to the future state exceeds a threshold value.

11. A non-transitory, computer-readable storage medium comprising instructions recorded thereon, wherein the instructions when executed by at least one data processor of a system, cause the system to:
input at least one security log file into a first machine learning (ML) model,
wherein the at least one security log file is generated at a first data domain of a telecommunication network, and
wherein the at least one security log file includes multiple cybersecurity events;
compute, using an output from the first ML model, a weighted sentiment value for one or more of the multiple cybersecurity events included in the at least one security log file;
using the weighted sentiment scores, detect, using a second ML model, an anomaly in a first cybersecurity event of the multiple cybersecurity events;
correlate, using a third ML model, the anomaly in the first cybersecurity event to a different anomaly in a second cybersecurity event associated with a second data domain;
determine, using a fourth machine learning model, a cybersecurity action to minimize a cyberattack using the weighted sentiment value and the correlation between the first cybersecurity event and the second cybersecurity event;
determine, using the fourth model, a predicted impact to the telecommunication network associated with execution of the cybersecurity action;
generate a prioritization ranking of the cybersecurity action against at least one other cybersecurity action associated with a different cyberattack; and
execute each cybersecurity action based on the prioritization ranking.

12. The non-transitory, computer-readable storage medium of claim 11, the system further caused to:
aggregate the weighted sentiment value for the multiple cybersecurity events over a predetermined time period.

13. The non-transitory, computer-readable storage medium of claim 12, the system further caused to:
link, using the third ML model, the first cybersecurity event to the second cybersecurity event based on the detected anomaly or a detected pattern in the aggregated weighted sentiment value of the first cybersecurity event to the second cybersecurity event.

14. The non-transitory, computer-readable storage medium of claim 11, the system further caused to:
calculate an impact value indicative of the predicted impact;
determine a new cybersecurity action when the impact value exceeds a threshold value.

15. The non-transitory, computer-readable storage medium of claim 11, wherein the first ML model, the second ML model, the third ML model, and the fourth ML model are the same ML model.

16. A method comprising:
inputting at least one security log file into a first machine learning (ML) model,
wherein the at least one security log file is generated at a first data domain of a telecommunication network, and
wherein the at least one security log file includes multiple cybersecurity events;
computing, using an output from the first ML model, a weighted sentiment value for one or more of the multiple cybersecurity events included in the at least one security log file;
using the weighted sentiment scores, detecting, using a second ML model, an anomaly in a first cybersecurity event of the multiple cybersecurity events;
correlating, using a third ML model, the anomaly in the first cybersecurity event to a different anomaly in a second cybersecurity event associated with a second data domain;
determining, using a fourth machine learning model, a cybersecurity action to minimize a cyberattack using the weighted sentiment value and the correlation between the first cybersecurity event and the second cybersecurity event;
determining, using the fourth model, a predicted impact to the telecommunication network associated with execution of the cybersecurity action;
generating a prioritization ranking of the cybersecurity action against at least one other cybersecurity action associated with a different cyberattack; and
executing each cybersecurity action based on the prioritization ranking.

17. The method of claim 16, further comprising:
aggregating the weighted sentiment value for the multiple cybersecurity events over a predetermined time period.

18. The method of claim 16, further comprising:
linking, using the third ML model, the first cybersecurity event to the second cybersecurity event based on the detected anomaly or a detected pattern in the aggregated weighted sentiment value of the first cybersecurity event to the second cybersecurity event.

19. The method of claim 16, wherein executing the cybersecurity action, further comprises:
generating programming code, using the LLM, based on the determined cybersecurity action,
wherein the programming code allows the system to execute the cybersecurity action; and
executing the programing code.

20. The method of claim 16, further comprising:
generating, using the fourth ML model, a recommendation in human readable format to implement a new cybersecurity protocol, cybersecurity technology, or to remove a cybersecurity technology from the telecommunication network.
